(19) United States
(12) Patent Application Publication
(10) Pub. No.: US 2009/0327801 A1
(43) Pub. Date: Dec. 31, 2009

(54) Disk array system, disk controller, and method for performing rebuild process

(75) Inventors: Chikashi Maeda, Kawasaki (JP); Mikio Ito, Kawasaki (JP); Hidejirou Daikokuya, Kawasaki (JP); Kazuhiko Ikeuchi, Kawasaki (JP); Hideo Takahashi, Kawasaki (JP); Yoshihito Konta, Kawasaki (JP); Norihide Kubota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/385,585

(22) Filed: Apr. 13, 2009

(30) Foreign Application Priority Data
Jun. 30, 2008 (JP) 2008-169871

(51) Int. Cl. G06F 11/20

(52) U.S. Cl. 714/6; 714/E11.091

(57) ABSTRACT

In a disk array system, when a failure occurs in a disk unit under control, a disk controller performs a rebuild process for rebuilding data stored on the faulty disk unit on a spare disk unit (HS). When a rebuild control section accepts an I/O request from a host before completing the rebuild process in all target areas, the rebuild control section specifies a management unit area including a target area of the I/O request and determines whether the rebuild process is completed in the management unit area. If the rebuild process is not completed in the management unit area, the rebuild control section performs the rebuild process in the management unit area by a rebuild process section and rebuilds data on the HS. After that, an I/O request handling section handles the I/O request.

### CROSS-REFERENCE TO RELATED APPLICATIONS

This application is based upon and claims the benefits of priority of the prior Japanese Patent Application No. 2008-169871, filed on Jun. 30, 2008, the entire contents of which are incorporated herein by reference.

### FIELD

The embodiment discussed herein is related to a disk array system, a disk controller, and a rebuild process method.

### BACKGROUND

With disk array systems including a plurality of disk units and a disk controller, the technology of a redundant array of inexpensive disks (RAID) is adopted in order to prevent data loss caused by a disk failure and to improve processing capability. A system in which the RAID technology is adopted is referred to as a RAID system.

With a RAID system, data is distributed on a plurality of disk units and redundancy is provided (except RAID 0). If one of disk units included in a RAID group is unable to be used due to, for example, a failure and redundancy is lost, then a rebuild process for recovering redundancy by assigning a spare disk unit in place of this disk unit and by rebuilding data on the spare disk unit is performed.

In order to rebuild data stored on the disk unit in which a failure has occurred, data is read out from a normal disk unit by certain processing units and restored data is written to a hot spare disk (HS) which is the spare disk unit. This step is repeated in the rebuild process. Such a rebuild process has traditionally been performed in order by predetermined processing units from the head of data to be rebuilt.

In addition, an upper host makes an I/O request for giving instructions to access a disk even while the rebuild process is being performed. When the I/O request is accepted, the I/O request is handled after completing the rebuild process by one processing unit. After that, the rebuild process is resumed. The method of increasing the size of processing units by which the rebuild process is performed in the case of an I/O request not being made by the host for a predetermined period is proposed (see, for example, Japanese Laid-Open Patent Publication No. 2007-94994).

However, a host may make an I/O request while a rebuild process is being performed. In such a case, the rebuild process takes a long time in the conventional RAID system because of overhead.

The host makes an I/O request regardless of whether the rebuild process is being performed. Therefore, there are cases where a request to access the same disk unit is made by both of the host and a disk controller.

For example, it is assumed that when an area of a normal disk unit is being accessed for performing a rebuild process, the host intensively accesses areas of the disk unit which are away from the area that is being accessed for performing the rebuild process. In this case, a disk seek process is performed each time between disk access for the rebuild process and disk access based on an I/O request. This may lead to overhead. Furthermore, the same problem arises when restored data is being written to an area of an HS. If the host intensively makes I/O requests for accessing areas which are away from the area that is now being written and which have already been written, a disk seek process is performed between the writing of the data in the rebuild process and disk access based on the I/O requests.

If the host makes an I/O request for accessing an area in which the rebuild process is not yet performed, access to a disk unit on which normal data is stored is needed instead of access to the spare disk unit. This involves the cost of a data restoration process at RAID levels other than RAID 1 (mirroring). For example, if the host makes an I/O request before restoring data on the HS, the data is restored in the same way that is described above, and then the I/O request is handled. For example, a parity operation unit is operated in order to restore the data. That is to say, time and a cost are needed for performing this process. In addition, the data is restored only in a target area of the I/O request. Accordingly, even if a target area of a next I/O request differs slightly from the target area of the above I/O request, a data restoration process is to be performed again. As a result, if the host makes an I/O request for accessing an area in which the rebuild process is not yet performed, overhead is incurred compared with the case where access is performed on the basis of an I/O request made in a normal state.

In recent years time taken to complete a rebuild process has become longer with an increase in the capacity of a disk. Therefore, a reduction in time taken to perform a rebuild process has become an important problem and the above overhead time is not negligible.

### SUMMARY

According to an aspect of the embodiment, a disk array system for distributing and storing data on a plurality of disk units and for accessing the plurality of disk units in response to an I/O request from a host includes: the plurality of disk units which stores distributed data and redundant data; a spare disk unit which functions in place of part of the plurality of disk. units in which a failure has occurred; and a disk controller including: a rebuild process section which restores data stored on a faulty disk unit by the use of data stored on disk units other than the faulty disk unit by management unit areas obtained by dividing a storage area of each disk unit by predetermined management units, and writes the data onto the spare disk unit; a management information storage section which stores rebuild management information including information which indicates whether a rebuild process is completed in each management unit area; and a rebuild control section which accepts the I/O request from the host, specifies a management unit area including a target area of the I/O request in the case of the target area of the I/O request being included in a target area of the rebuild process, rebuilds data in the management unit area by the rebuild process section in the case of the determination that the rebuild process is not yet completed in the management unit area specified being made on the basis of the rebuild management information, and permits the I/O request after rebuilding the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view of one embodiment;

FIG. 2 illustrates an example of the structure of a RAID system according to the embodiment;

FIG. 3 illustrates an example of the structure of each disk unit;

FIG. 4 illustrates an example of rebuild management information;

FIG. 5 gives an overview of a procedure for a rebuild process;

FIG. 6 gives an overview of a procedure for I/O request handling performed on an area in which the rebuild process is not yet performed;

FIG. 7 gives an overview of a procedure for I/O request handling performed on an area in which the rebuild process is already performed;

FIG. 8 is a flow chart describing a procedure for the process of accepting an I/O request from a host;

FIG. 9 is a flow chart describing the procedure for the rebuild process;

FIG. 10 is a flow chart describing a procedure for a caching process; and

FIG. 11 is a flow chart describing a procedure for a cache management process.

### DESCRIPTION OF EMBODIMENT(S)

An embodiment of the present invention will be described below with reference to the accompanying drawings, wherein like reference numerals refer to like elements throughout. The concept of the embodiment will be described first and then the concrete contents of the embodiment will be described.

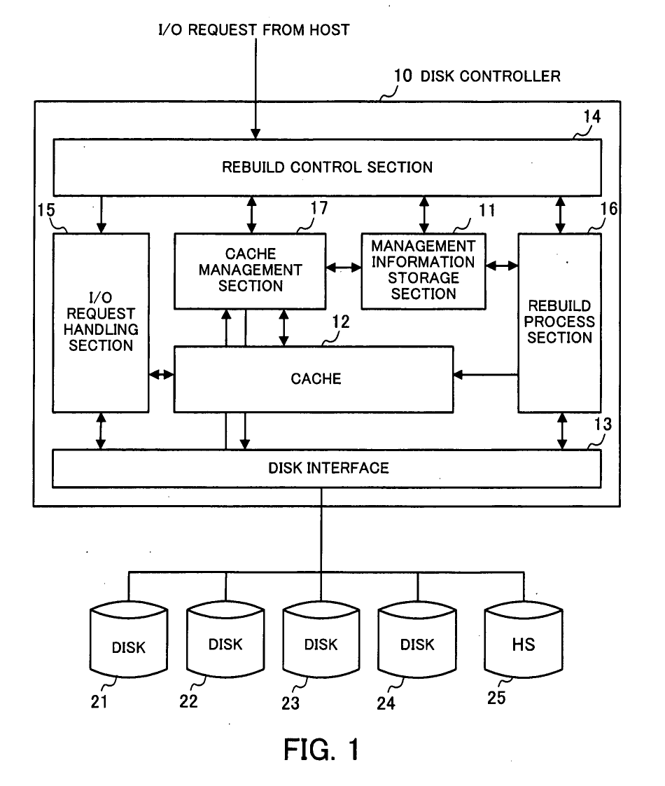

FIG. 1 is a schematic view of the embodiment.

A disk array system according to the embodiment includes disk units 21, 22, 23, and 24 for distributing and storing redundant data, an HS 25 which is a spare disk unit, and a disk controller 10 and handles an I/O request from a host (not illustrated).

The redundant data is divided by predetermined blocks, is distributed among the disk units 21, 22, 23, and 24, and is stored thereon. Data after division by the blocks is stored on the disk units 21, 22, 23, and 24 like a strip (in a stripe). Hereinafter divided data and redundant data (parity, for example) stored in a stripe will be referred to as stripe data.

The HS 25 is in a standby state when the disk units 21, 22, 23, and 24 are normal. When a failure occurs in one of the disk units 21, 22, 23, and 24, the HS 25 functions in place of a faulty disk unit. At this time the disk controller 10 performs a rebuild process to rebuild data stored on the faulty disk unit on the HS 25.

The disk controller 10 includes management information storage section 11, a cache 12, a disk interface 13, a rebuild control section 14, an I/O request handling section 15, a rebuild process section 16, and a cache management section 17.

The management information storage section 11 is a memory in which various pieces of management information which the disk controller 10 refers to for performing a process are stored. Management information including structure information and rebuild management information is stored in the management information storage section 11. For example, the structure of the real disk units 21, 22, 23, and 24 and HS 25 corresponding to RAID logical units (RLUs) are defined in the structure information. Information regarding each of predetermined management unit areas obtained by dividing a storage area of each disk unit by predetermined management units is set in the rebuild management information. For example, a rebuild implementation situation in each management unit area and the number of I/O requests for each management unit area made by the host are set.

The cache 12 is a cache memory to which data frequently accessed of data stored in the disk units 21, 22, 23, and 24 and the HS 25 is copied and in which the data frequently accessed is temporarily stored.

The disk interface 13 is an interface with the disk units 21, 22, 23, and 24 and the HS 25.

When the rebuild control section 14 accepts an I/O request from the host, the rebuild control section 14 controls the whole of a rebuild process in order to handle the I/O request. If a rebuild process is not being performed or if a target area of the I/O request is not a target area of a rebuild process, then the rebuild control section 14 makes the I/O request handling section 15 make a response to the I/O request. If the target area of the I/O request is a target area of the rebuild process, then the rebuild control section 14 specifies a management unit area in which the target area of the I/O request is included from access destination information included in the I/O request. In addition, the rebuild control section 14 increments a “Number of I/O Requests from Host” item of the rebuild management information corresponding to the management unit area specified. The rebuild control section 14 determines on the basis of the rebuild management information whether the rebuild process is completed in this management unit area. If the rebuild process is not completed in this management unit area, then the rebuild control section 14 starts the rebuild process section 16 and makes the rebuild process section 16 perform the rebuild process in this management unit area. After the rebuild process is completed, the rebuild control section 14 makes the I/O request handling section 15 handle the I/O request. If the rebuild process is completed in this management unit area, then the rebuild control section 14 makes the I/O request handling section 15 handle the I/O request after a cache management process performed by the cache management section 17.

The I/O request handling section 15 converts the access destination information (logical unit number on the RLUs) specified in the I/O request from the host to a physical block address on a disk unit on the basis of the structure information regarding each disk unit. Then the I/O request handling section 15 accesses the corresponding disk unit 21, 22, 23, or 24 or HS 25 via the disk interface 13 and handles the I/O request made by the host. If pertinent data is stored in the cache 12, then the I/O request handling section 15 accesses the data stored in the cache 12. The I/O request handling section 15 makes a copy of the data read out from the disk unit 21, 22, 23, or 24 or the HS 25 at need and stores the copy in the cache 12. A series of cache operations is performed in the same way that is used in a conventional method for handling an I/O request, so detailed descriptions of it will be omitted.

The rebuild process section 16 performs a rebuild process in each management unit area. The rebuild process section 16 begins a rebuild process in, for example, an area the address of which is the lowest of areas where data is to be rebuilt. The rebuild process section 16 reads out stripe data in the same stripe corresponding to a management unit area from normal disk units other than a faulty disk unit and restores data stored in the management unit area. Then the rebuild process section 16 writes the data to a corresponding area of the HS 25 and sets a rebuild implementation situation of the rebuild management information corresponding to the management unit area to “Rebuild Process Completed”. When the rebuild control section 14 gives the rebuild process section 16 instructions in response to an I/O request from the host, the rebuild process section 16 performs a rebuild process in a management unit area designated in the same way that is described above. Then the rebuild process section 16 stores the data restored in the management unit area and the stripe data (excluding redundant data) read out from the normal disk units in the cache 12. After the rebuild process corresponding to the I/O request is completed, a rebuild process is performed next in an arbitrary management unit area. A rebuild process may be performed in a management unit area next to a management unit area in which a rebuild process was performed before the rebuild process corresponding to the I/O request. Furthermore, a rebuild process may be begun in a management unit area next to the management unit area in which the rebuild process corresponding to the I/O request was performed.

The cache management section 17 manages the cache 12. If data stored in the specified management unit area is not stored in the cache 12, then the cache management section 17 reads out the data and stores the data in the cache 12. In addition, the cache management section 17 calculates the number of I/O requests accepted from the host during a predetermined period on the basis of “Number of I/O Requests from Host” for each management unit area set in the rebuild management information, and determines whether the number is greater than a specified value determined in advance. If the number is greater than the specified value, then the cache management section 17 performs setting so that the data stored in the specified management unit area will be resident in the cache 12. When the data stored in the specified management unit area is made resident in the cache 12, the whole of data stored in a same stripe managed by the specified management unit area is stored in the cache 12. On the other hand, if, for example, the condition that an I/O request is not made for a certain period of time is met, then “cache resident” is released so that page-out can be performed.

The operation of the disk controller 10 having the above structure and a procedure for a rebuild process will be described.

The disk controller 10 monitors the state of the disk units 21, 22, 23, and 24 on which data is distributed and stored by a monitoring section (not illustrated). When an I/O request is accepted from the host in the case of the disk units 21, 22, 23, and 24 being in a normal state, the I/O request handling section 15 performs ordinary I/O request handling and returns a response to the host.

If the disk controller 10 detects that a failure has occurred in one of the disk units 21, 22, 23, and 24, then the rebuild process section 16 begins a rebuild process. For example, it is assumed that a failure has occurred in the disk unit 21. The rebuild process section 16 reads out divided data from each management unit area of the normal disk units 22, 23, and 24 and restores data stored in each management unit area of the faulty disk unit 21. The restored data is written onto the HS 25 and the data is rebuilt on the HS 25. After a rebuild process is completed in each management unit area, a rebuild implementation situation of the rebuild management information corresponding to each management unit area is set to “Rebuild Process Completed”.

It is assumed that while the rebuild process section 16 is performing a rebuild process in order in this way, an I/O request is inputted from the host. The rebuild control section 14 determines whether a target area of the I/O request made by the host is a target area of the rebuild process. If the target area of the I/O request is not the target area of the rebuild process, then the I/O request handling section 15 performs the ordinary I/O request handling as in ordinary cases. If the target area of the I/O request is the target area of the rebuild process, then the rebuild control section 14 specifies a management unit area in which the target area of the I/O request is included from access destination information included in the I/O request, and increments the “Number of I/O Requests from Host” item of the rebuild management information corresponding to the management unit area specified. Then the rebuild control section 14 determines on the basis of the rebuild management information whether the rebuild process is completed in this management unit area. If the rebuild process is not completed in this management unit area, then the rebuild control section 14 starts the rebuild process section 16 and makes the rebuild process section 16 perform the rebuild process in this management unit area. The rebuild process section 16 writes restored data onto the HS 25 and stores the restored data and a data portion of stripe data read out from the normal disk units in the cache 12. After that, the rebuild control section 14 makes the I/O request handling section 15 handle the I/O request. If the rebuild process is completed in this management unit area, then data stored in this management unit area is written to the cache 12 and the I/O request handling section 15 handles the I/O request. In addition, the cache management section 17 calculates the number of I/O requests accepted from the host during a predetermined period on the basis of the number of I/O requests from the host which is set in the rebuild management information, and determines whether the number is greater than a specified value determined in advance. If the number is greater than the specified value, then the cache management section 17 makes the data stored in this management unit area resident in the cache 12.

When an I/O request for accessing an area in which a rebuild process is not yet completed is accepted during the rebuild process in the above RAID system, the rebuild process is performed in a corresponding management unit area and then the I/O request is handled. As a result, when the host makes an I/O request later for accessing the management unit area, a data restoration process can be omitted. In addition, when the rebuild process is performed, restored data and stripe data (excluding redundant data) which is stored on normal disk units and which is read out for data restoration are stored in the cache 12. This reduces contention between an I/O request made by the host for accessing a normal disk unit and a read process performed in a rebuild process or between an I/O request made by the host for accessing the HS 25 and a write process performed in the rebuild process. As a result, time taken to perform the rebuild process can be reduced.

In addition, the number of I/O requests is managed by management unit areas. If the determination that the host intensively makes an I/O request for accessing a management unit area in which a rebuild process is being performed can be made on the basis of the number of I/O requests made during a predetermined period, then data stored in this management unit area is always stored in the cache 12. This reduces the number of times this management unit area is accessed in response to an I/O request from the host.

That is to say, contention between disk access based on an I/O request and disk access in a rebuild process is reduced. As a result, seek time can be reduced.

An embodiment will now be described in detail with reference to the drawings by taking the case where the embodiment is applied to a RAID 5 disk array system as an example.

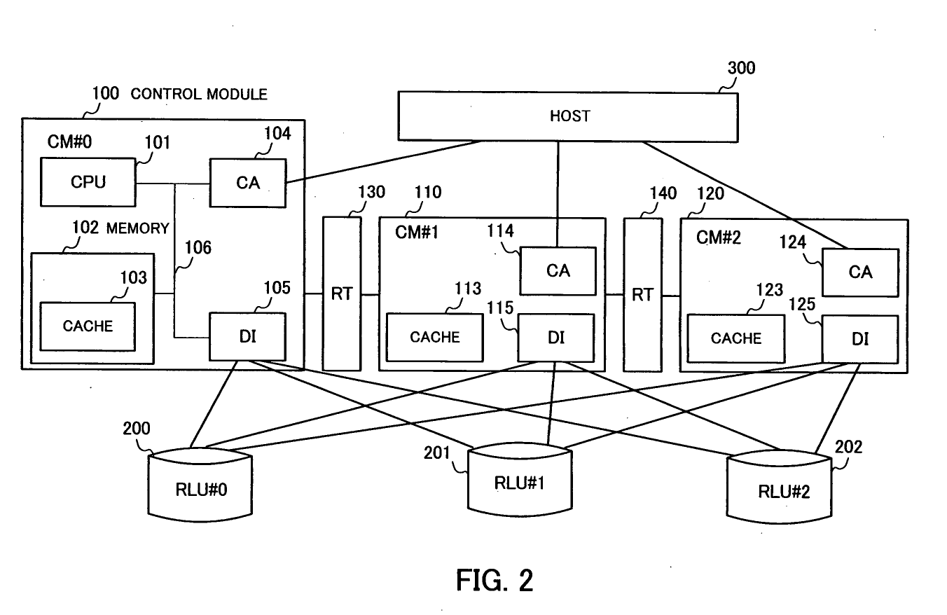

FIG. 2 illustrates an example of the structure of a RAID system according to the embodiment.

With a RAID system according to the embodiment, RAID logical units RLU#0 (200), RLU#1(201), and RLU#2 (202) which make up a RAID 5 disk array are connected to a host 300 via control modules (CMs) CM#0 (100), CM#1 (110), and CM#2 (120). The CM#0 (100) and the CM#1 (110) are connected via a router RT130 and the CM#1 (110) and the CM#2 (120) are connected via a router RT140.

Each of the CM#0 (100), CM#1 (110), and CM#2 (120) is a disk controller. That is to say, each of the CM#0 (100), CM#1 (110), and CM#2 (120) handles an I/O request accepted from the host 300. In addition, if a failure has occurred in part of the disk array under control, each of the CM#0 (100), CM#1 (110), and CM#2 (120) performs a rebuild process for rebuilding data on an HS. There is also control module redundancy. That is to say, if a failure has occurred in one of the CMs, the others back up a faulty CM.

The hardware configuration of the control module CM#0 (100) will now be described. The whole of the CM#0 (100) is controlled by a central processing unit (CPU) 101. A memory 102, a channel adapter (CA) 104, a disk interface (DI) 105, and the like are connected to the CPU 101 via a bus 106.

The CPU 101 and the memory 102 are backed up by a battery and part of the memory 102 is used as a cache 103. The CA 104 is a circuit which functions as an interface with the host 300. The DI 105 is a circuit which functions as an interface with each disk unit. The hardware configuration of the CM#1 (110) and CM#2 (120) is the same as that of the CM#0 (100). That is to say, the CM#1 (110) includes a cache 113, a CA 114, and a DI 115 and the CM#2 (120) includes a cache 123, a CA 124, and a DI 125.

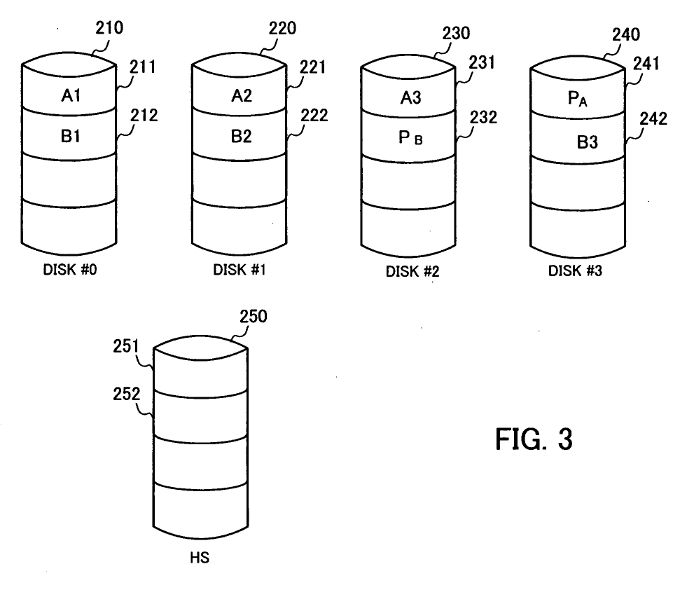

The structure of each disk unit will now be described. FIG. 3 illustrates an example of the structure of each disk unit.

In this example, four disk units (disk #0 (210), disk #1 (220), disk #2 (230), and disk #3 (240)) and a spare disk unit (HS) 250 are included in the RAID 5 system. Divided stripe-size data and parity generated from the divided data are stored in the same stripe on the disk #0 (210), the disk #1 (220), the disk #2 (230), and the disk #3 (240). For example, data A is divided into data A1, data A2, and data A3. Then the data A1, the data A2, the data A3, and parity P_{A} are stored in blocks 211, 221, 231, and 241 on the disk #0 (210), the disk #1 (220), the disk #2 (230), and the disk #3 (240) respectively. Similarly, data B is divided into data B1, data B2, and data B3. Then the data B1, the data B2, the data B3, and parity P_{B} are stored in blocks 212, 222, 242, and 232 respectively. The reason for adopting the above structure is as follows. When a failure occurs in one of the four disk units, data stored on a faulty disk unit can be restored by the use of divided data and parity data stored in the same stripe on the other normal disk units. It is assumed that stripe areas on the HS 250 corresponding to the data A and the data B are blocks 251 and 252 respectively.

A management unit area which is a processing unit in a rebuild process is an area obtained by dividing an area on a disk by predetermined units. One management unit area is referred to as an entry. For example, it is assumed that the maximum capacity of RLUs made by the use of a 1-terabyte (TB) disk as a large capacity disk is a logical volume viewed from the host. An area on the disk is divided by the 64 depth (=8,192 lba=4 MB). In this case, the number of entries (logical block addresses) necessary for managing the entire disk can be calculated as follows:

(1,024×1, 024×1,024×1,024)+512+128+64=262,144

where 1 lba=512 bytes and 1 depth=128 lba.

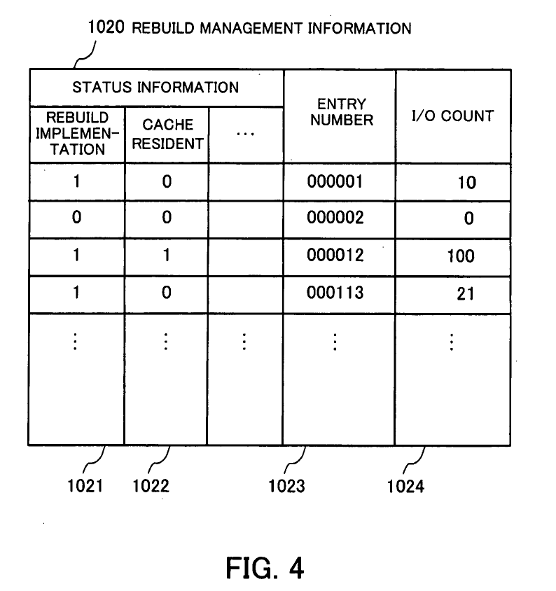

The rebuild management information for managing a rebuild process will now be described. FIG. 4 illustrates an example of the rebuild management information.

Rebuild management information 1020 includes a Status Information item which includes Rebuild Implementation 1021 and Cache Resident 1022 and which indicates the situation of a rebuild process, an Entry Number item 1023 for specifying a target entry, and an I/O Count item 1024 corresponding to each entry.

The Rebuild Implementation 1021 is information which indicates a rebuild implementation situation on an entry specified by the Entry Number item 1023, that is to say, information which indicates whether a rebuild process is completed in an entry specified by the Entry Number item 1023. In this example, a state in which a rebuild process is completed is indicated by “1” and a state in which a rebuild process is not yet completed is indicated by “0”. The Cache Resident 1022 is information which indicates whether data that is stored in a corresponding entry and that is stored in a cache is set as cache resident data. In this example, cache resident data is indicated by “1” and cache non-resident data is indicated by “0”. If data stored in an entry is set as cache resident data, then the data stored in the entry is not paged out from the cache. If another piece of information is necessary as status information, then it is set properly. In order to reduce an area in which the rebuild management information is stored, each piece of status information may be held as bit information.

A unique identification number assigned to each entry for specifying is set in the Entry Number item 1023.

The number of I/O requests made by the host for accessing each entry is set in the I/O Count item 1024. To detect whether the host frequently makes an I/O request for accessing an entry, it is necessary to count the number of I/O requests made by the host during a predetermined period. Accordingly, a counter is initialized in a constant cycle. Each time an I/O request is made, the counter is incremented. By doing so, the number of I/O requests made during the predetermined period is counted.

The rebuild management information is stored in a table area (area in which various tables for managing the operation of each CM are stored) of a memory included in each CM. The rebuild management information is to be held regardless of whether power to each CM is turned on/off or whether power supply stops/resumes. In addition, when a failure occurs in a CM, a backup CM takes over the rebuild management information and an RLU under its control. Therefore, the rebuild management information is an object of backup/listing. In addition, a duplex system is adopted and the rebuild management information is managed by a pair of CMs. This is the same with data stored in each cache.

The operation of the RAID system having the above structure will be described. Unless specially mentioned, hereinafter the same components or the like that are illustrated in FIG. 2, 3, or 4 are marked with the same numbers.

The ordinary operation of the RAID system which is performed when disk units are in a normal state will be described first. For example, when a control module CM#0 (100) accepts an I/O request (read) inputted from a host 300 via a CA 104, the control module CM#0 (100) checks whether data corresponding to the I/O request is stored in a cache 103. If the data is stored in the cache 103, then the control module CM#0 (100) reads out the data and transfers the data as an I/O response to the host 300 via the CA 104. If the data is not stored in the cache 103, then the control module CM#0 (100) reads out the data from a physical disk (disk #0 (210), disk #1 (220), disk #2 (230), or disk #3 (240)) and transfers the data to the host 300 via the CA 104. At this time the control module CM#0 (100) stores a copy of the data in the cache 103. In the following descriptions the process of reading out data from a disk and storing the data in the cache 103 will be referred to as staging. The above series of access steps is ordinary I/O request handling. With a write process, write back to a physical disk is also performed. However, the other procedures are the same with the read process. Therefore, the following descriptions will be given with the case where the read process is performed as an example.

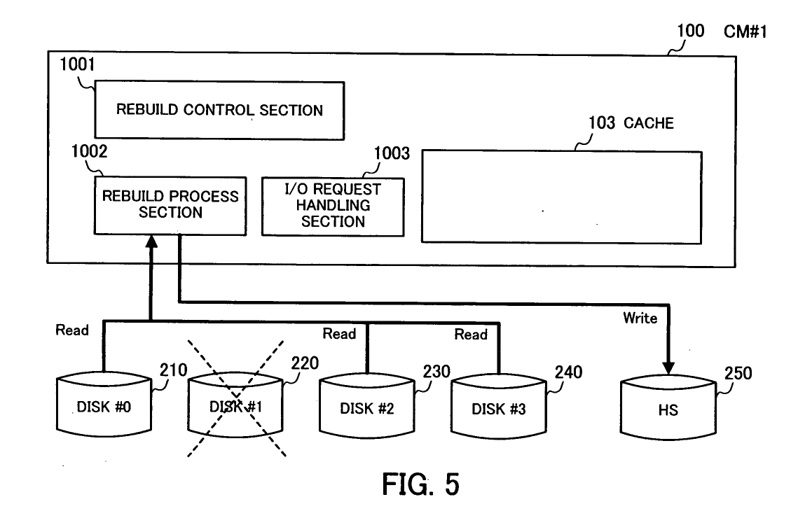

If a failure occurs in one of the physical disks (disk #0 (210), disk #1 (220), disk #2 (230), and disk #3 (240)), then a rebuild process for rebuilding data on an HS 250 is begun. FIG. 5 is a view for giving an overview of a procedure for a rebuild process.

In this example, it is assumed that a failure has occurred in the disk #1 (220). A rebuild process section 1002 restores data in order from the head of physical addresses of the disk #1 (220) with an entry as a processing unit and writes the data onto an HS 250. For example, the rebuild process section 1002 reads out data A1, data A3, and parity P_{A} from a block 211 on the disk #0 (210), a block 231 on the disk #2 (230), and a block 241 on the disk #3 (240), respectively, by entries and restores data A2 by the use of them. Then the rebuild process section 1002 writes the restored data A2 to a corresponding area on the HS 250. At this time the rebuild process section 1002 registers “rebuild performed” in a Status Information item of rebuild management information 1020 corresponding to an entry number. The rebuild process section 1002 repeats the above procedure and rebuilds data stored in the disk #1 (220) on the HS 250.

The case where an I/O request is inputted from the host 300 while the above rebuild process is being performed will be described. A rebuild control section 1001 determines whether a target RLU of the I/O request inputted from the host 300 is performing the rebuild process. If the target RLU of the I/O request inputted from the host 300 is not performing the rebuild process, then the rebuild control section 1001 converts an access destination designated by a logical block of an RLU to a physical block address and specifies a corresponding entry. At this time the rebuild control section 1001 increments an I/O Count item 1024 of the rebuild management information 1020 corresponding to the entry. Then the rebuild control section 1001 refers to the rebuild management information 1020 and determines whether the rebuild process has been performed in the entry specified.

If the above procedure is followed, the case where the access destination of the I/O request is not an object of the rebuild process, the case where the rebuild process is not yet performed in the access destination of the I/O request, and the case where the rebuild process is already performed in the access destination of the I/O request are possible. If the access destination of the I/O request is not an object of the rebuild process, then the ordinary I/O request handling is performed. Accordingly, its descriptions will be omitted. The case where the rebuild process is not yet performed in the access destination of the I/O request and the case where the rebuild process is already performed in the access destination of the I/O request will be described.

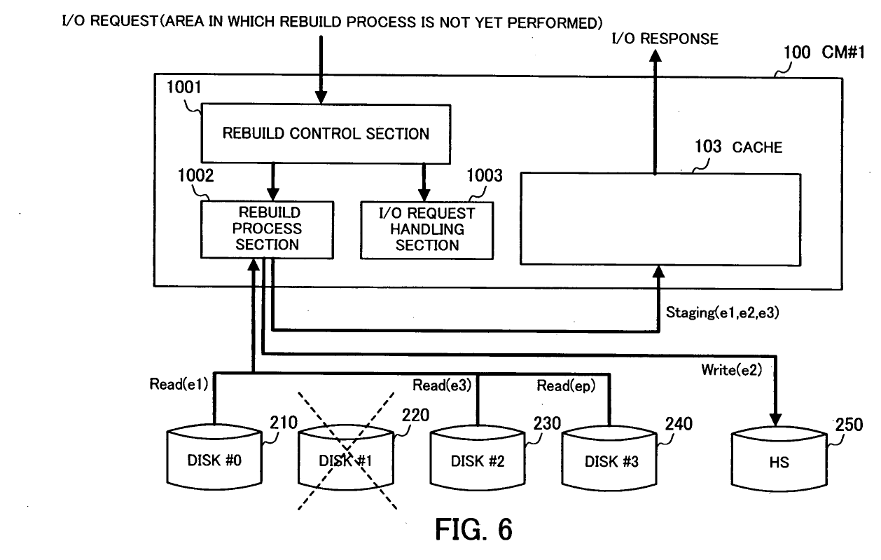

A procedure done in the case where the access destination of the I/O request is an object of the rebuild process and where the rebuild process is not yet performed in the access destination of the I/O request will be described first. FIG. 6 is a view for giving an overview of a procedure for I/O request handling performed on an area in which the rebuild process is not yet performed.

If the rebuild process is not yet performed in the access destination of the I/O request, then the rebuild control section 1001 gives the rebuild process section 1002 instructions to perform the rebuild process in a corresponding entry. The rebuild process section 1002 begins the rebuild process with the designated entry as a target. Information for restoring the target entry, that is to say, data stored in a same stripe on the normal disk units is read out first. In this example, data e1, data e3, and parity ep are read out from the disk #0 (210), the disk #2 (230), and the disk #3 (240) respectively. Data e2 is restored by a parity operation process. Data (data e1 and data e3 read out and data e2 restored, in this example) which is managed by the entry and which is stored in the same stripe is staged to the cache 103. The parity ep is not staged. Then the data e2 restored is written onto the HS 250. By doing so, data in the entry including the access destination of the I/O request is rebuild on the HS 250. Then Rebuild Implementation 1021 of the rebuild management information 1020 corresponding to the target entry is set to “rebuild performed”. After that, the rebuild control section 1001 makes an I/O request handling section 1003 handle the I/O request. The I/O request handling section 1003 returns an I/O response to the host by the use of the data staged to the cache 103.

As has been described, if the rebuild process is not yet performed in the access destination of the I/O request made by the host 300, the rebuild process is performed in the corresponding entry and then the I/O request is handled. By doing so, data in the entry including the access destination of the I/O request is rebuild on the HS 250. Therefore, when access to another piece of data in the entry is made by an I/O request made later, there is no need to perform a data restoration process again. In addition, at this time not only the restored data but also the data which is managed by the entry and which is stored in the same stripe is staged to the cache 103. Accordingly, even if the host 300 intensively makes an I/O request later for accessing this entry, there is no need to access the disk units.

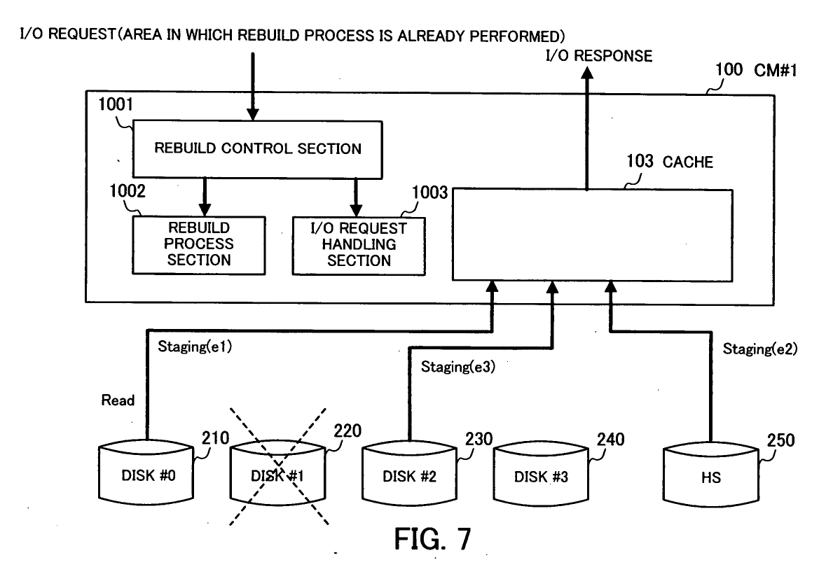

A procedure done in the case where the access destination of the I/O request is an object of the rebuild process and where the rebuild process is already performed in the access destination of the I/O request will be described next. FIG. 7 is a view for giving an overview of a procedure for I/O request handling performed on an area in which the rebuild process is already performed.

If the rebuild process is already performed in the access destination of the I/O request, then the rebuild control section 1001 determines whether data in an access destination area resides in the cache 103. If the data in the access destination area resides in the cache 103, then the rebuild control section 1001 returns an I/O response by the use of the data which resides in the cache 103. If the data in the access destination area does not reside in the cache 103, then the rebuild control section 1001 reads out the data in the access destination area from a corresponding area of the HS 250 in which the rebuild process is already performed, and returns an I/O response. At the same time the data in the access destination area read out is staged to the cache 103.

At this time the rebuild control section 1001 refers to the rebuild management information 1020 and compares a value indicated in the I/O Count item 1024 corresponding to an appropriate entry with a specified value. If the number of I/O requests is greater than the specified value, data in the whole of a stripe managed by this entry is staged to the cache 103. For example, if area of the HS 250 managed by this entry corresponds to the data e2, then the data e1, the data e3, and the data e2 are read out from the disk #0 (210), the disk #2 (230), and the HS 250, respectively, as data in the whole of a stripe, and are staged to the cache 103. The parity ep stored on the disk #3 (240) is not staged to the cache 103. In addition, a “request to make resident” is issued so that the data managed by this entry will be resident in the cache 103. If the data can be made resident in the cache 103, then a cache management section that manages the cache 103 sets the Cache Resident column 1022 of the rebuild management information 1020 corresponding to this entry to “resident”. As a result, the data is resident in the cache 103.

As has been described, data in the whole of a stripe managed by an entry for which the host frequently makes an I/O request, that is to say, an entry access to which will most likely occur in the future is staged to cache 103. As a result, contention between disk access based on an I/O request made later by the host and disk access in a rebuild process can be reduced.

A procedure for a process performed by each section of the RAID system having the above structure will now be described by the use of a flow chart.

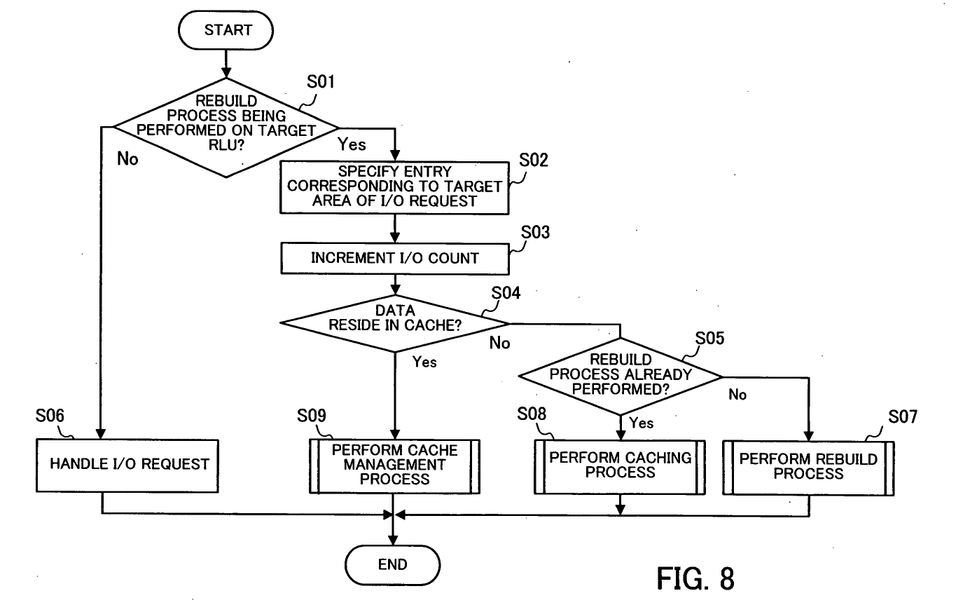

FIG. 8 is a flow chart describing a procedure for the process of accepting an I/O request from the host. When an I/O request is inputted from the host, a process is begun.

[Step S01] Access destination information included in the I/O request is acquired, and whether a rebuild process is being performed on a target RLU to which a logical address of an access destination belongs is determined on the basis of the structure information. If a rebuild process is being performed on the target RLU, then step S02 is performed. If a rebuild process is not being performed on the target RLU, then step S06 is performed.

[Step S02] If a rebuild process is being performed on the target RLU, then the rebuild process is controlled in order to reduce contention between access for handling the I/O request and access for performing the rebuild process. An entry corresponding to the target RLU is specified first. slba (block number as a logical volume) and the number of blocks are used for making the I/O request. Therefore, slba is converted to plba (block number on a disk) by the use of the RAID level, the number of RLU member disks, and the structure information regarding OLUs. An entry corresponding to a target area of the I/O request is specified on the basis of plba after the conversion.

[Step S03] The I/O Count item 1024 of the rebuild management information 1020 corresponding to the entry specified in step S02 is incremented.

[Step S04] Whether data for which the I/O request is made resides in the cache 103 is checked. For example, when data in an entry is staged to the cache 103, the staging of the data in the entry is left in the Status Information item of the rebuild management information 1020. By doing so, whether the data for which the I/O request is made resides in the cache 103 can be determined on the basis of the rebuild management information 1020. If the data for which the I/O request is made does not reside in the cache 103, then step S05 is performed. If the data for which the I/O request is made resides in the cache 103, then step S09 is performed.

[Step S05] If a rebuild process is being performed on the target RLU and the data corresponding to the I/O request does not reside in the cache 103, then whether the rebuild process is already performed in the specified entry is determined on the basis of the Rebuild Implementation column 1021 of the rebuild management information 1020. If the rebuild process is not yet performed in the specified entry, then step S07 is performed. That is to say, the rebuild process is performed in the specified entry. If the rebuild process is already performed in the specified entry, then step S08 is performed. That is to say, a caching process is performed.

[Step S06] If a rebuild process is not being performed on the target RLU, then contention between access for handling the I/O request and access for performing a rebuild process does not occur. Accordingly, the ordinary I/O request handling is performed. After an I/O response is returned to the host, the procedure is completed.

[Step S07] If a rebuild process is being performed on the target RLU and the rebuild process is not yet performed in the specified entry, then the rebuild process is performed in the specified entry. Details will be described later. After the rebuild process is performed in the specified entry, restored data for which the I/O request is made is returned to the host and the procedure is completed.

[Step S08] If a rebuild process is being performed on the target RLU and the rebuild process is already performed in the specified entry, then a caching process is performed and data rebuilt in the specified entry is stored in the cache 103. Details will be described later. After the caching process is performed, the data for which the I/O request is made is returned to the host and the procedure is completed. Details will be described later.

[Step S09] If a rebuild process is being performed on the target RLU and the data for which the I/O request is made resides in the cache 103, then a cache management process is performed and whether to make the data resident in the cache 103 is determined. After the cache management process is performed, the data for which the I/O request is made is returned to the host and the procedure is completed.

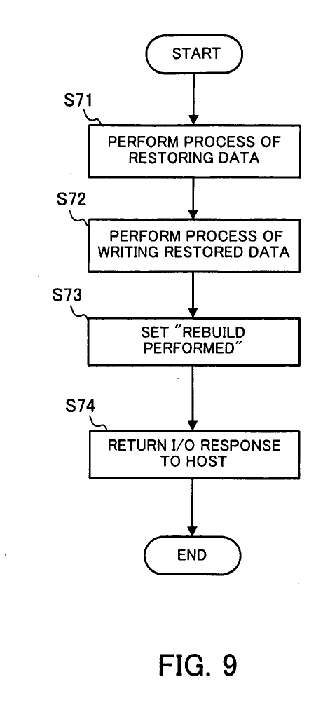

The rebuild process performed in the case of the rebuild process not yet being performed in the target area of the I/O request will be described. FIG. 9 is a flow chart describing the procedure for the rebuild process.

If the rebuild process is not yet performed in the entry specified as the target area of the I/O request, the procedure is begun.

[Step S71] Data stored in an area managed by the entry is read out from normal disk units and is staged to the cache 103. In addition, parity is read out from a normal disk unit and data stored on the faulty disk unit is restored by the use of the data previously read out and the parity. The restored data is also staged to the cache 103.

[Step S72] The data restored in step S71 is written to a corresponding area of the HS 250 to rebuild the data.

[Step S73] The Rebuild Implementation column 1021 of the Status Information item of the rebuild management information 1020 corresponding to the specified entry is set to “rebuild performed”.

[Step S74] The data corresponding to the target area of the I/O request is returned to the host as an I/O response and the procedure is completed.

If the I/O request is made by the host for an area in which the rebuild process is not yet performed, the above procedure is performed. By doing so, the rebuild process is performed in the entry including the target area, and the data is restored. The data read out from the normal disk units for restoring the data and the restored data are staged to the cache 103.

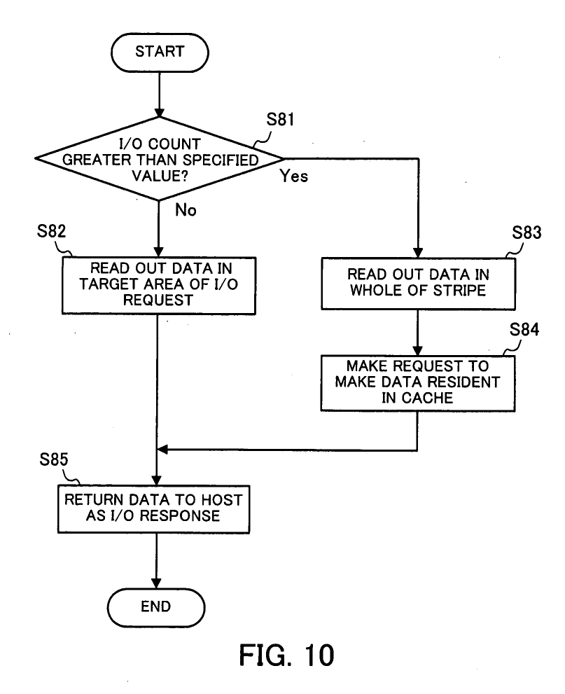

The caching process performed in the case of the rebuild process being already performed in the target area of the I/O request will now be described. FIG. 10 is a flow chart describing a procedure for the caching process.

If the rebuild process is already performed in the entry specified as the target area of the I/O request, the procedure is begun.

[Step S81] An I/O count corresponding to the specified entry is read out from the I/O Count item 1024 of the rebuild management information 1020 and is compared with the specified value. If the I/O count is not greater than the specified value, that is to say, if the host does not make an I/O request for the specified entry frequently, then step S82 is performed. If the I/O count is greater than the specified value, that is to say, if the host makes an I/O request for the specified entry frequently, then step S83 is performed.

[Step S82] If the I/O count is not greater than the specified value, then data in the target area of the I/O request is read out from restored data stored in the specified entry of the HS 250 and is staged to the cache 103. Then step S85 is performed.

[Step S83] If the I/O count is greater than the specified value, then restored data stored in the specified entry of the HS 250 is read out, data in the whole of a stripe managed by the specified entry is read out from the normal disk units, and this data is staged to the cache 103.

[Step S84] A request to make the data staged to the cache 103 in step S82 or S83 resident in the cache 103 is made. If this request is allowed, then the Cache Resident column 1022 of the rebuild management information 1020 corresponding to the specified entry is set to “cache resident” and the data in the specified entry is resident in the cache 103.

[Step S85] After the data in the target area of the I/O request is staged to the cache 103, the data in the target area of the I/O request is returned to the host as an I/O response and the procedure is completed.

If the number of I/O requests made by the host for the specified entry is higher than the predetermined specified value, the above procedure is performed. By doing so, the data in the whole of the stripe managed by the specified entry is staged to the cache 103 and is set as cache resident data.

A cache management process performed in the case of the data in the target area of the I/O request residing in the cache 103 will now be described. This cache management process is performed in the case where, for example, after data pertinent to the entry in which the rebuild process is performed by the procedure illustrated in FIG. 9 is staged to the cache 103, an I/O request is made again for this entry. In addition, this cache management process is performed in the case where the data is staged to the cache 103 by the procedure illustrated in FIG. 10.

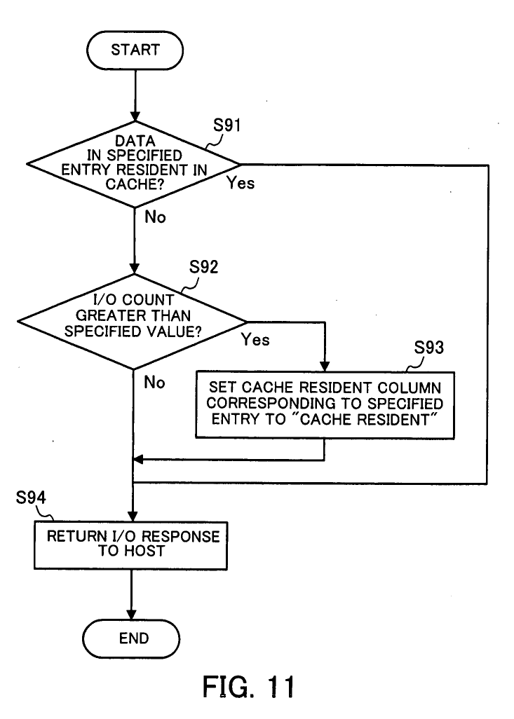

FIG. 11 is a flow chart describing a procedure for the cache management process. If the data in the entry specified as the target area of the I/O request resides in the cache 103, the procedure is begun.

[Step S91] In order to determine whether the data in the entry specified is resident in the cache 103, information corresponding to the entry specified is read out from the Cache Resident column 1022 of the rebuild management information 1020 and whether “cache resident” is set is checked. If “cache resident” is not set, then step S92 is performed. If “cache resident” is set, then step S94 is performed.

[Step S92] If the data in the entry specified is not set as cache resident data, then the number of I/O requests made by the host for the specified entry during a predetermined period is read out from the I/O Count item 1024 of the rebuild management information 1020 and is compared with the specified value. If the I/O count is greater than the specified value, then step S93 is performed.

[Step S93] If the I/O count is greater than the specified value, then the Cache Resident column 1022 of the rebuild management information 1020 corresponding to the specified entry is set to “cache resident”.

[Step S94] The data in the target area of the I/O request is returned to the host as an I/O response and the procedure is completed.

By performing the above procedure, the number of I/O requests made by the host for each entry is calculated. If the I/O count is greater than the predetermined specified value, then data in an entry is resident in the cache 103.

The I/O Count item 1024 and the Cache Resident column 1022 of the rebuild management information 1020 are initialized to 0 by a timer or task started in a predetermined cycle. When the host makes an I/O request later for an entry, counting up begins. Therefore, while the host continues to make an I/O request, a value other than zero is set in the I/O Count item 1024. However, if the host rarely makes an I/O request, then the I/O count is low. If the host does not make an I/O request, then the I/O count is zero. For example, if a value in the I/O Count item 1024 is zero for a predetermined period, then “cache resident” in the Cache Resident column 1022 is released.

The case where the embodiment is applied to a RAID 5 system has been described. However, the embodiment can be applied to a RAID system other than a RAID 5 system.

With the disk array system, the disk controller, and the method for performing a rebuild process according to the embodiment, the following way is adopted. If the host makes an I/O request for an area in which a rebuild process is not yet completed, then the rebuild process is performed in a predetermined management unit area including a target area of the I/O request. After that, the I/O request is handled. As a result, data is preferentially rebuilt in the management unit area including the target area of the I/O request made by the host. Accordingly, if the host continuously makes an I/O request with a predetermined area as an access destination, access for handling an I/O request made later can be completed in the same time that is taken in a normal state. As a result, time taken to perform a rebuild process can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that various changes, substitutions and alterations could be made hereto without departing from the spirit and scope of the invention.

What is claimed is:

1. A disk array system for distributing and storing data on a plurality of disk units and for accessing the plurality of disk units in response to an I/O request from a host, the system comprising:
the plurality of disk units which stores distributed and redundant data;
a spare disk unit which functions in place of part of the plurality of disk units in which a failure has occurred; and
a disk controller including:
a rebuild process section which restores data stored on a faulty disk unit by the use of data stored on disk units other than the faulty disk unit by management unit areas obtained by dividing a storage area of each disk unit by predetermined management units, and writes the data onto the spare disk unit;
a management information storage section which stores rebuild management information including information which indicates whether a rebuild process is completed in each management unit area; and
a rebuild control section which accepts the I/O request from the host, specifies a management unit area including a target area of the I/O request in the case of the target area of the I/O request being included in a target area of the rebuild process, rebuilds data in the management unit area by the rebuild process section in the case of the determination that the rebuild process is not yet completed in the management unit area specified being made on the basis of the rebuild management information, and permits the I/O request after rebuilding the data.

2. The disk array system according to claim 1, wherein:
the rebuild process section performs an ordinary rebuild process for rebuilding data on the spare disk unit in order at predetermined timing by the management unit areas; and
the rebuild process section resumes the ordinary rebuild process in a management unit area next to a management unit area in which the rebuild process is performed before the I/O request after the rebuild process is completed in the management unit area which corresponds to the target area of the I/O request and in which the rebuild control section instructs the rebuild process section to perform the rebuild process.

3. The disk array system according to claim 1, wherein:
the rebuild process section performs an ordinary rebuild process for rebuilding data on the spare disk unit in order at predetermined timing by the management unit areas; and
the rebuild process section resumes the ordinary rebuild process in a management unit area next to the management unit area in which the rebuild process is performed in response to the I/O request after the rebuild process is completed in the management unit area which corresponds to the target area of the I/O request and in which the rebuild control section instructs the rebuild process section to perform the rebuild process.

4. The disk array system according to claim 1, wherein:
the disk controller includes a cache memory for temporarily storing a copy of data in area selected from the plurality of disk units and the spare disk unit and a cache management section for managing the cache memory;
the rebuild control section calculates a number of I/O requests for each management unit area which are from the host and which are accepted during a predetermined period, and sets the number in the rebuild management information; and
the cache management section compares the number of I/O requests for each management unit area which are from the host with a predetermined specified value on the basis of the rebuild management information, and makes data in each management unit area resident in the cache memory in the case of the number of I/O requests for each management unit area which are from the host being greater than the specified value.

5. The disk array system according to claim 4, wherein if a target management unit area of the rebuild process includes the target area of the I/O request from the host, the rebuild process section stores data in a same stripe which corresponds to the target management unit area, which is used for restoring data in the target management unit area, and which is read out from the disk units other than the faulty disk unit in the cache memory.

6. The disk array system according to claim 4, wherein if the number of I/O requests for a management unit area which are from the host is greater than the specified value and data in the management unit area is not stored in the cache memory, the cache management section makes the data in the management unit area resident in the cache memory and stores data in a same stripe corresponding to the management unit area in the cache memory.

7. A disk controller for distributing and storing data on a plurality of disk units and for accessing the plurality of disk units in response to an I/O request from a host, the disk controller comprising:
a rebuild process section which restores data stored on a faulty disk unit by the use of data stored on disk units other than the faulty disk unit by management unit areas obtained by dividing a storage area of each of the plurality of disk units for storing distributed data and redundant data by predetermined management units, and writes the restored data onto a spare disk unit which functions in place of the faulty disk unit;
a management information storage section which stores rebuild management information including information which indicates whether a rebuild process is completed in each management unit area; and
a rebuild control section which accepts the I/O request from the host, for specifying a management unit area including a target area of the I/O request in the case of the target area of the I/O request being included in a target area of the rebuild process, rebuilds data in the management unit area by the rebuild process section in the case of the determination that the rebuild process is not yet completed in the management unit area specified being made on the basis of the rebuild management information, and permits the I/O request after rebuilding the data.

8. A method for performing a rebuild process by a disk array system for distributing and storing data on a plurality of disk units and for accessing the plurality of disk units in response to an I/O request from a host, the method comprising:
restoring data stored on a faulty disk unit by the use of data stored on disk units other than the faulty disk unit by management unit areas obtained by dividing a storage area of each of the plurality of disk units for storing distributed data and redundant data by predetermined management units, and writing the restored data onto a spare disk unit which functions in place of the faulty disk unit by a rebuild process section;
accepting the I/O request from the host, specifying a management unit area including a target area of the I/O request in the case of the target area of the I/O request being included in a target area of the rebuild process, reading out rebuild management information including information which indicates whether the rebuild process is completed in each management unit area from a management information storage section, and determining by a rebuild control section on the basis of the rebuild management information whether the rebuild process is not yet completed in the management unit area specified;
rebuilding data in the management unit area by the rebuild process section in the case of the determination that the rebuild process is not yet completed in the management unit area; and
permitting the I/O request, by the rebuild control section, after rebuilding the data by the rebuild process section.
